(19) United States
(12) Patent Application Publication
(10) Pub. No.: US 2009/0231136 A1
(43) Pub. Date: Sep. 17, 2009

(54) TAGS AND TAG-BASED SYSTEMS AND METHODS FOR LOCATING AND TRACKING OBJECTS

(76) Inventors: Binay SUGLA, Holmdel, NJ (US); Gerard Lazzaro, New Milford, CT (US)

Correspondence Address: STRAUB & POKOTYLO, 788 Shrewsbury Avenue, TINTON FALLS, NJ, 07724, US

(21) Appl. No.: 12/266,793

(22) Filed: Nov. 7, 2008

Related U.S. Application Data
(60) Provisional application No. 61/035,931, filed on Mar. 12, 2008.

(51) Int. Cl. G08B 13/14

(52) U.S. Cl. 340/572.1

(57) ABSTRACT

The accuracy and reliability of tracking and locating is increased by using a unique combination of at least two locating technologies. This may be done while reducing the costs for achieving a given level of accuracy and reliability, leveraging existing standard technologies, delivering room level location accuracy, providing choke point capabilities, providing RTLS capability minimizing additional infrastructure costs and maintenance costs, and/or increasing battery life of tags. Information for locating a tag within a region, the region including a plurality of zone or boundary identifier transmitters and a plurality of access points may be combined by (a) receiving by the tag, from one of the zone or boundary identifier transmitters, a zone or boundary identifier, (b) transmitting by the tag, information identifying the zone or boundary identifier and a tag identifier associated with the tag, over at least two channels, (c) receiving, by at least two of the access points, the information identifying the zone or boundary identifier and a tag identifier associated with the tag, transmitted by the tag, (d) transmitting, by each of the at least two access points, the information identifying the zone or boundary identifier and a tag identifier associated with the tag, as well as secondary information for use in deriving a location of the tag, and (e) storing the zone or boundary identifier and the tag identifier associated with the tag, and the secondary information, in association with one another.

### § 0. RELATED APPLICATIONS

This application claims the benefit of provisional application Ser. No. 61/035,931 (referred to as “the '931 application” and incorporated herein by reference), titled “A NEW CLASS OF HYBRID TAGS AND ARCHITECTURE FOR LOCATIONING AND TRACKING,” filed on Mar. 12, 2008, and listing Binay Sugla as the inventor. This present application is not limited by any specific aspects of any of the embodiments described in the '931 provisional.

### § 1. BACKGROUND OF THE INVENTION

§ 1.1 Field of the Invention

The present invention concerns using tags to locate objects. More specifically, the present invention concerns using multiple technologies to better locate an object within a region, such as a building for example.

§ 1.2 Background Information

Tracking and locating objects using “tags” that are explicitly or implicitly associated with objects has been of great interest. Global positioning satellite (“GPS”) based systems have been popular for determining outdoor locations, but have some limitations. Barcode is another form of tracking that has become ubiquitous. A third class of tags, called radio frequency identification (“RFID”), employing radio frequencies have become very popular.

Early RFID tags employed largely proprietary techniques including proprietary radio, capacitance and inductive technologies. In recent years the focus has shifted to the use of standardized technologies to obtain better performance at lower costs.

There are two major types of RFID tags—passive and active. Passive tags have no batteries (or do not require a battery power source) while active tags include a battery. Therefore, passive RFID tags can theoretically operate in perpetuity, while active RFID tags need to have their battery replaced or recharged periodically. Passive RFID tags are typically powered by an external passive RFID reader which provides them with electromagnetic waves at certain frequencies and/or modulations with adequate power. More specifically, passive RFID tags are energized upon receiving these electromagnetic waves, modulate the waves and reflect them back to the reader with a fraction of the received energy. Due to attenuation with distance, a small fraction of this power is received at the reader. Passive tags, therefore, are suitable for proximity or choke point-based detection. That is, typically, an object with a passive RFID tag can be tracked only when it crosses the proximity of choke points that have RFID readers installed.

Active RFID tags can be used both as a proximity tag, a choke point tag (where they can have a higher range and can be detected more reliably than the passive tags), or both. Active RFID tags can be used for GPS like real-time locating (“RTLS”) technology. With RTLS, a tag's location is determined continuously using an array of outdoor or indoor “satellites”. For RTLS, standardized technologies like Wi-Fi, offer distinct advantages as the Wi-Fi access points can serve the dual purpose of Internet connectivity and as indoor reference “satellites” to determine the position of the tag at all times.

In practice, there are a number of challenges associated with using passive RFID or active RFID technologies to track objects in an indoor environment. For example, passive RFID tags require RFID readers to be placed at all locations that object needs to be tracked. In large facilities (e.g. such as an average hospital which has on the order of 1000 rooms), this implies that an RFID reader chokepoint has to be installed at the entrance of every room. This involves wiring and is relatively expensive to install and maintain. Additionally, the real-time tracking capability between choke points is absent. As another example, active tags deploying standardized technologies (such as Wi-Fi, for example) deliver 15-30 foot accuracy which is typically insufficient for room-level accuracy. For example, if an object is located close to a wall or a corner of a room, then the object could be placed in any of the rooms within a 15-30 feet radius of the tagged object.

In view of the foregoing, it would be useful to better track and locate objects, particularly in an indoor space.

### § 2. SUMMARY OF THE INVENTION

At least some embodiments consistent with the present invention improve tracking and locating objects, particularly in an indoor space. Such embodiments may

combine information for locating a tag within a region (the region including a plurality of zone or boundary identifier transmitters and a plurality of access points) by (a) receiving by the tag, from one of the zone or boundary identifier transmitters, a zone or boundary identifier, (b) transmitting by the tag, information identifying the zone or boundary identifier and a tag identifier associated with the tag, over at least two channels, (c) receiving, by at least two of the access points, the information identifying the zone or boundary identifier and a tag identifier associated with the tag, transmitted by the tag, (d) transmitting, by each of the at least two access points, the information identifying the zone or boundary identifier and a tag identifier associated with the tag, as well as secondary information for use in deriving a location of the tag, and (e) storing the zone or boundary identifier and the tag identifier associated with the tag, and the secondary information, in association with one another.

An exemplary tag consistent with the present invention might include (a) a storage device storing a tag identifier for identifying the tag apparatus, (b) a receiver adapted to receive a zone or boundary identifier from a zone or boundary identifier transmitter, (c) a packet processor adapted to generate a packet including a zone or boundary identifier received by the receiver and the tag identifier stored in the storage device, (d) a transmitter adapted to transmit a packet generated by the packet processor over at least two channels, wherein a location of the tag can be derived from an attribute of receptions of the transmitted packet by at least two access point devices tuned to the at least two channels, and (e) an untethered power source.

An exemplary system consistent with the present invention might include a tag and at least two access points. In such an exemplary system, the tag may include a storage device storing a tag identifier for identifying the tag, a receiver adapted to receive a zone or boundary identifier from a zone or boundary identifier transmitter, a packet processor adapted to generate a packet including a zone or boundary identifier received by the receiver and the tag identifier stored in the storage device, a transmitter adapted to transmit a packet generated by the packet processor over at least two channels, and an untethered power source. In such an exemplary system, each of the at least two access points may include a receiver tuned to one of the at least two channels and adapted to receive a packet transmitted by the transmitter of the tag, and a transmitter adapted to transmit a packet received by its receiver, as well as secondary information for use in deriving a location of the tag.

### § 3. BRIEF DESCRIPTION OF THE DRAWINGS

FIG. 1 illustrates an exemplary environment in which, or with which, embodiments consistent with the present invention may be used.

FIG. 2 is a flow diagram showing an exemplary method, consistent with the present invention, which may be performed by a choke point or zone transmitter.

FIG. 3 is a flow diagram showing an exemplary method, consistent with the present invention, which may be performed by a tag.

FIG. 4 is a flow diagram showing an exemplary method, consistent with the present invention, which may be performed by an access point.

FIG. 5 is a flow diagram showing an exemplary method, consistent with the present invention, which may be performed by a controller.

FIG. 6 is an exemplary data structure which may be used to carry a zone or boundary identifier in a manner consistent with the present invention.

FIG. 7 illustrates an exemplary packet, consistent with the present invention, in which zone or boundary ID and tag ID information is inserted.

FIG. 8 illustrates an exemplary packet, consistent with the present invention, carrying packet of FIG. 7.

FIG. 9 is a block diagram of apparatus 900 that may be used to perform at least some operations, and store at least some information, in a manner consistent with the present invention.

### § 4. DETAILED DESCRIPTION

Exemplary environments in which, or with which, embodiments consistent with the present invention may be used are described in § 4.1 below. Then, exemplary methods, data structures and apparatus, consistent with the present invention, are described in §§ 4.2-4.4, respectively. Thereafter, refinements, alternatives and extensions are described in § 4.5. Finally, some conclusions are discussed in § 4.6.

### § 4.1 Exemplary Environment in which, or with which, Embodiments Consistent with the Present Invention May be Used

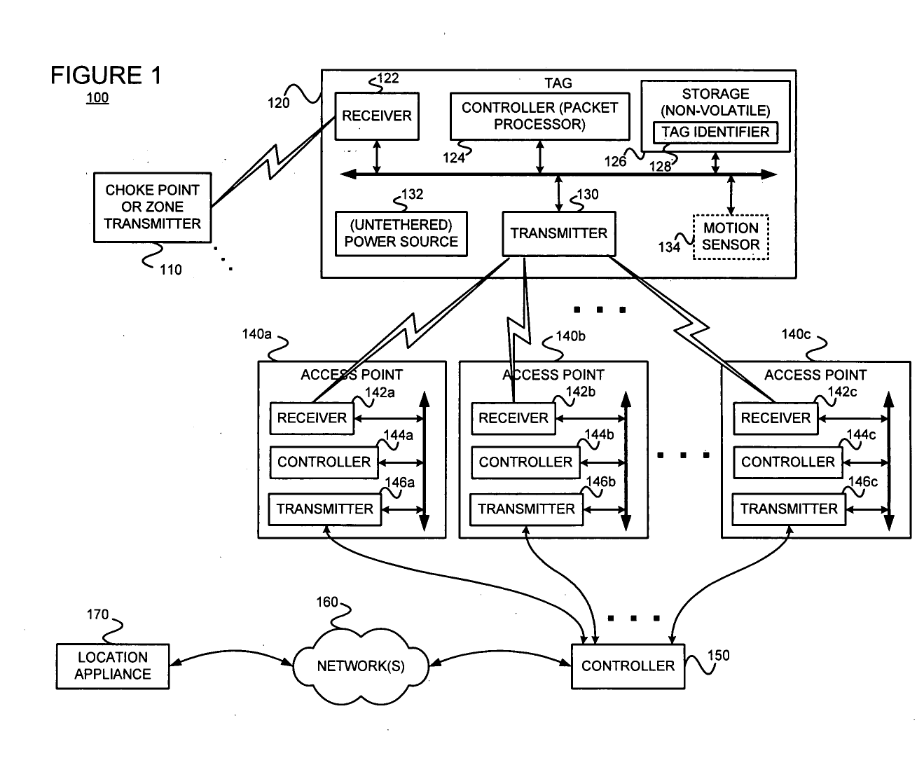

FIG. 1 illustrates an exemplary environment 100 in which, or with which, embodiments consistent with the present invention may be used. The exemplary environment 100 includes a choke point or zone transmitter 110, a tag 120 fixed to an object (not shown) to be tracked, a plurality of access points 140, a controller 150, and a location appliance 170. The controller 150 and the location appliance may communicate via one or more networks 160, such as the Internet for example. In practice, the environment 100 will include a plurality of choke point or zone transmitters 110 and a plurality of tags 120. However, only one of each is shown for simplicity.

The tag 120 may receive a transmission (detailed examples of which are described below) from the choke point or zone transmitter 110. The access points 140 may receive transmissions (detailed examples of which are described below) from the tag 120. Finally, the controller 150 may receive transmissions from the access points 140, and may store information included in such transmissions. Information stored in the controller 150 may be provided to (e.g., pushed to, or pulled from) the location appliance 170.

The choke point or zone transmitter 110 may include an infrared (IR) transmitter for transmitting a boundary or zone identifier. The IR transmitter emits an IR light beam, modulated by the data being sent to create a digital representation of the data, over the air to the receiver 122 in the tag 120. Other types of transmitters such as, for example, ultrasound, Zigbee, Bluetooth, Ultra Wide Band, etc., may be used instead of, or in addition to, IR transmitters. The choke point or zone transmitter 110 might be characterized as a low-power (e.g., a range of about 10-20 feet) transmitter, or a line-of-sight transmitter. The transmitter 110 might have minimal or no penetration of walls. The transmitter 110 might use a carrier that reflects well. The transmitter 110 might be AC or battery powered. In some environments, the transmitter 110 might be provided in or on the frame of a door or entry wall. In such environments, the transmitter 110 might be aligned to cause reflections of the carrier on the door frame, and/or floor. In some environments, two (e.g., line of sight) transmitters 110 might be provided at a zone boundary, such as a doorway (for purposes of determining whether a tag is entering or leaving a zone).

The tag 120 may include a receiver 122, a controller (packet processor) 124, (e.g., a non-volatile) storage 126 storing a tag identifier 128, a transmitter 130 and a (e.g., untethered) power source 132. The tag 120 may also include a motion sensor 134. The receiver 122 of the tag 120 should be able to receive transmissions from the choke point or zone transmitter 110 when the tag 120 crosses a boundary (enters or leaves a zone) or when the tag 120 is within a zone corresponding to the transmitter 110. The controller 124 may be used to generate a message or packet (detailed examples of which are described below) including (1) a boundary or zone identifier associated with the choke point or zone transmitter 110, and (2) the tag identifier 128 stored in storage 126 (or information derived from such identifiers). The transmitter 130 may be one or more WiFi transmitters for transmitting information on multiple channels (e.g., channels 1, 6 and 11) to multiple access points 140. The power source 132 may be a battery. In some embodiments, the battery may be charged (e.g., via solar power, motion and magnetic induction, thermal difference, etc.). The motion sensor 134 may be, for example, a tilt and vibration defection switch that produces a toggling hi and low signal from which a representation of motion can be derived. The receiver 122 and/or the transmitter 130 of the tag 120 may be controlled based on motion detected by motion sensor 134 in order to conserve power.

Each of the access points 140 may be WiFi access points including a receiver 142, a controller 144 and a transmitter 146. The receivers 142 of the access points 140 may be tuned to different WiFi channels (e.g., channels 1, 6 and 11). The transmitters 146 of the access points 140 may communicate information to the controller 150 using the lightweight access point protocol (“LWAPP”) or other (e.g., proprietary or open) protocol used by the wireless infrastructure employed (e.g., GRE, etc.). That is, the protocol used is not critical. The transmitted information may include (1) the zone or boundary identifier received, (2) the tag identifier received, and (3) secondary information for use in deriving a location of the tag.

When the controller 150 receives the information communicated from the access points, it may store such information. If the controller 150 receives a request for the stored information from the location appliance 170 (pull), or if a push condition is met, the controller 150 forwards the stored information (or information derived from the stored information) to the location appliance 170 via one or more network(s) 160.

The location appliance 170 may determine a location of the tag using both (1) the zone or boundary identifier stored in association with the tag identifier associated with the tag, and (2) the secondary information stored in association with the tag identifier associated with the tag. Alternatively, the location appliance 170 may (1) determine a first estimated location of the tag using the zone or boundary identifier stored in association with the tag identifier associated with the tag, (2) determine a second estimated location of the tag using the secondary information stored in association with the tag identifier associated with the tag, and (3) determine a refined location using the determined first estimated location and the determined second estimated location.

Exemplary methods of operation of the choke point or zone transmitter 110, the tag 120, the access points 140 and the controller 150 are described in § 4.2 below. Exemplary message formats of communications among these components are described in § 4.3 below.

### § 4.2 Exemplary Methods

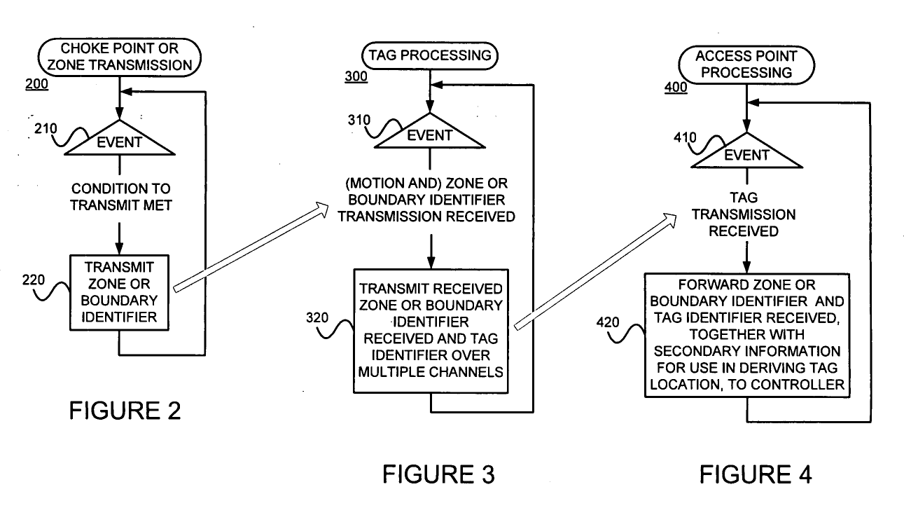

FIGS. 2-4 are flow diagrams showing exemplary methods, consistent with the present invention, which may be performed by a choke point or zone transmitter (110), a tag (120) and an access point (140), respectively. Each is described below.

FIG. 2 is a flow diagram showing an exemplary method 200, consistent with the present invention, which may be performed by a choke point or zone transmitter (110). In a typical application, there will be multiple choke point or zone transmitters, each of which might perform the method 200. As indicated by event block 210, when a condition to transmit is met, a zone or boundary identifier 220 is transmitted (Block 220). The zone or boundary identifier may be used to define a region, or to define an entry or exit point of the region. The condition to transmit may be timer-based, such that the zone or boundary identifier is transmitted every predetermined number of seconds, or milli-seconds (for example, from 0.2 to 1.0 second).

FIG. 3 is a flow diagram showing an exemplary method 300, consistent with the present invention, which may be performed by a tag (120). In a typical application, there will be multiple tags, each of which might perform the method 300. As indicated by event block 310, when a zone or boundary identifier transmission is received, the received identifier is transmitted, together with a tag identifier, over multiple channels (Block 320). Referring back to event block 310, the tag might also have to be moving before it will transmit. More specifically, the tag might not even power its receiver when it is not moving (since its location will not change). However, when the tag detects that it is moving, it will power its receiver (e.g., for a predetermined period of time), which allows it to receive zone or boundary identifier transmissions. More generally,

in some embodiments consistent with the present invention the zone or boundary identifier received by the tag is received by a receiver having a first state (motion detected, or motion detected within a predetermined time) in which the receiver is enabled more frequently than a second state (no motion detected, or no motion for a predetermined period for time) in which the receiver is enabled less frequently or disabled. Similarly, in some embodiments consistent with the present invention, the (e.g., WiFi) transmitter has a first state (motion detected, or motion detected within a predetermined time) in which the WiFi transmitter transmits more frequently than a second state (no motion detected, or no motion for a predetermined period for time) in which the WiFi transmitter transmits less frequently or is disabled.

Referring back to block 320, the transmission might occur over multiple WiFi channels (e.g., 1, 6 and 11). Such transmissions might be performed in parallel, by multiple transmitters. However, in order to reduce the cost of the tag, it may be advantageous to transmit over the multiple channels sequentially, by a single transmitter. For example, three channels may be transmitted in a 10 msec burst.

Referring back to event 310, in alternative embodiments consistent with the present invention, the condition for performance of block 320 might be independent of the receipt of a zone or boundary identifier transmission, and/or might be subject to one or more further conditions. For example, another condition might be that the received zone or boundary identifier is different from the last received zone or boundary identifier.

FIG. 4 is a flow diagram showing an exemplary method 400, consistent with the present invention, which may be performed by an access point (140). In a typical application, there will be multiple access points (at least one for each channel), each of which might perform the method 400. As indicated by event block 410, when a tag transmission is received, the zone or boundary identifier and tag identifier received are forwarded, together with secondary information for use in deriving tag location, to a controller (Block 420). In at least some embodiments consistent with the present invention, the secondary information includes a received signal strength. In at least some embodiments consistent with the present invention, the secondary information is included in a received 802.11 message.

Referring back to event 410, in alternative embodiments consistent with the present invention, the condition for the performance of block 420 might be independent of the receipt of the tag transmission, and/or might be subject to one or more further conditions.

Referring back to blocks 220 of FIGS. 2 and 310 of FIG. 3, the zone or boundary identifier may be transmitted by an infra-red transmitter and received by an infra-red receiver. Alternatively, the zone or boundary identifier may be transmitted by an ultra-sound transmitter and received by an ultra-sound receiver. As yet another alternative, the zone or boundary identifier may be transmitted by a radio-frequency transmitter and received by an radio-frequency receiver. The radio-frequency transmitter and receiver might use the Zigbee protocol or the Bluetooth protocol.

Still referring back to blocks 220 of FIGS. 2 and 310 of FIG. 3, the zone or boundary identifier might be a zone (e.g., room) identifier. Alternatively, the zone or boundary identifier might be a boundary identifier. A typical application might include both zone and boundary identifiers (transmitted by different choke point or zone transmitters).

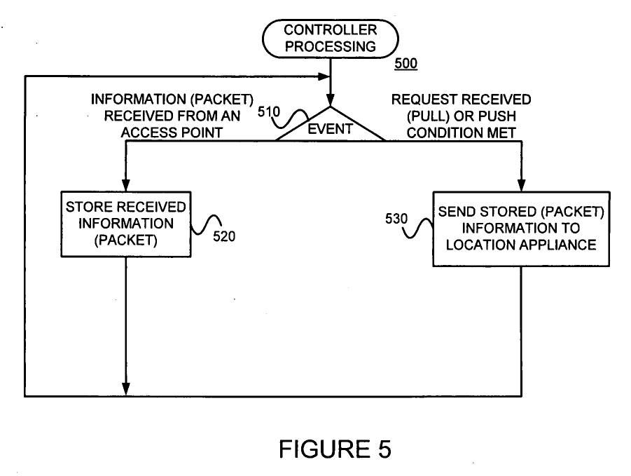

FIG. 5 is a flow diagram showing an exemplary method 500, consistent with the present invention, which may be performed by a controller (150). Various branches of the method 500 may be performed responsive to various conditions. For example, if the controller receives the information communicated from the access points, it may store such information (Block 520). If the controller receives a request for the stored information (e.g., from the location appliance) (“pull”), or if a “push” condition is met, the controller forwards the stored information (or information derived from the stored information) to the location appliance (e.g., via one or more network(s)) (Block 530).

The present invention is not limited to any of the methods described.

### § 4.3 Exemplary Data Structures

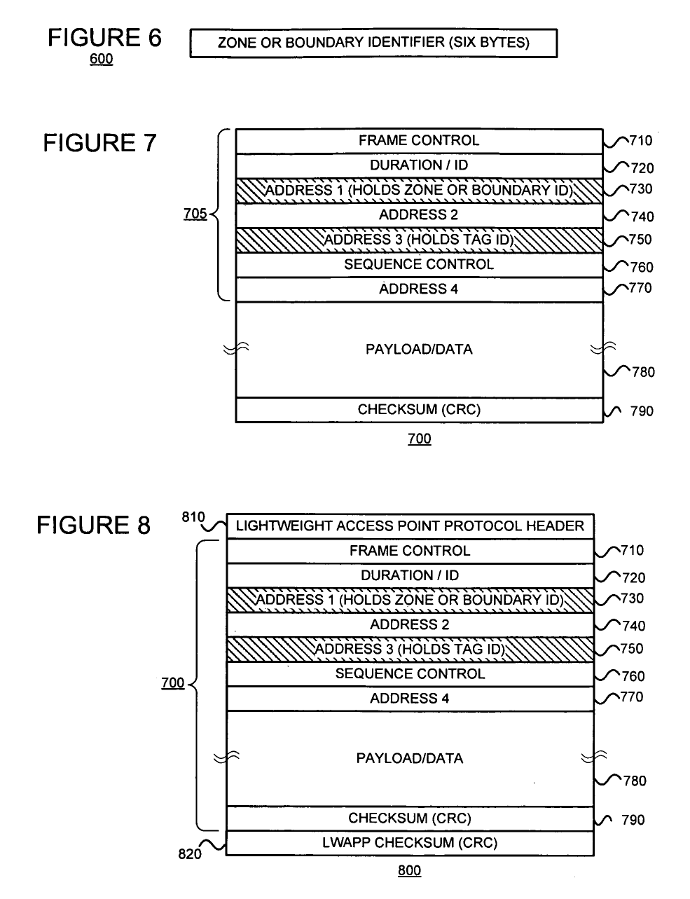

As illustrated by data structure 600 of FIG. 6, in at least some embodiments consistent with the claimed invention, the zone or boundary identifier transmitted by the choke point or zone transmitter 110 and received by the tag 120, and/or transmitted by the tag 120 is six (6) bytes (or less). This advantageously allows this information to be carried in an 802.11 protocol MAC frame address field, as described below.

FIG. 7 illustrates an 802.11 protocol MAC frame packet 700 in which zone or boundary ID and tag ID information is inserted. In at least some embodiments consistent with the present invention, this packet 700 may be transmitted, over at least two channels, by the tag. Generally, a header portion 705 of the packet 700 includes a two (2) byte frame control field 710, a two (2) byte duration field 720, three (3), six (6) byte address fields 730, 740 and 750, a two (2) byte sequence control field 760, and another six (6) byte address field 770. The data portion 780 of the packet 700 may include a payload of between 0 and 2312 bytes. Finally, the packet 700 may include a four (4) byte checksum (CRC) field 790. As shown, in at least some embodiments consistent with the present invention, the first address field 730 may carry the zone or boundary identifier and the third address field 750 may carry the tag identifier. In alternative data structures consistent with the present invention, the zone or boundary identifier and/or the tag identifier may be carried in address fields other than that shown, or may be carried in the payload 780.

FIG. 8 illustrates a lightweight access point protocol (“LWAPP”) packet 800 carrying the 802.11 protocol MAC frame packet 700. In at least some embodiments consistent with the claimed invention, this packet 800 may be transmitted by an access point. As shown, the packet includes an LWAPP header 810, the packet 700, and an LWAPP checksum (CRC) 820. The packet 800 may include secondary information (e.g., time of receipt, received signal strength, etc.) from which the location of the tag may be derived.

The present invention is not limited to any of the data structures described.

### § 4.4 Exemplary Apparatus

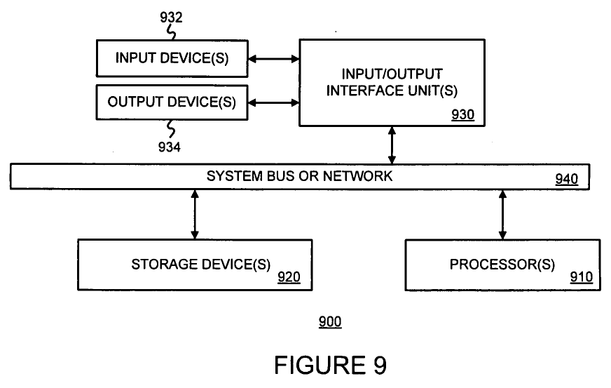

FIG. 9 is a block diagram of apparatus 900 that may be used to perform at least some operations, and store at least some information, in a manner consistent with the present invention. The apparatus 900 basically includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930.

The one or more processors 910 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 920 and/or may be received from an external source via one or more input interface units 930.

In one embodiment, the machine 900 may be one or more wireless access points or conventional personal computers. (However, one skilled in the art would recognize that it would be advantageous if certain components (such as transmitter 110, tag 120 and access points 140 of FIG. 1 for example) were not implemented on a personal computer. That is, such components might be implemented in hardware (e.g., using circuits, integrated circuits, application specific integrated circuits, programmable logic arrays, etc.), and/or software.) In this case, the processing units 910 may be one or more microprocessors. The bus 940 may include a system bus. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 932, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 910 through an appropriate interface 930 coupled to the system bus 940. The output devices 934 may include a monitor or other type of display device, which may also be connected to the system bus 940 via an appropriate interface. In addition to (or instead of) the monitor, the personal computer may include other (peripheral) output devices (not shown), such as speakers and printers for example.

At least some of the operations described above may be performed on one or more computers. Such computers may communicate with each other via one or more networks, such as the Internet for example.

### § 4.5 Refinements, Alternatives and Extensions

The environment 100 may be a hospital. In such an environment, three (3) to ten (10) 802.11 access points 140 may be provided on each floor.

Although the tag was described as transmitting information over multiple (e.g., 802.11) channels, in some embodiments consistent with the present invention, the tag may transmit using multiple different transmission technologies.

In at least some embodiments consistent with the present invention, the controller may be preprogrammed to forward “tag” packets (which are not associated with the 802.11 network) to the location appliance. Alternatively, the controller may be provided with the MAC address identifiers (or a similar digital representation of a tag ID) of all of the tags, and might forward only those MAC addresses corresponding to known tags to the location appliance. Thus, other data structures, in which transmitter information (e.g., zone of boundary ID) is inserted into a WiFi packet which is transmitted over multiple channels, may be used instead.

Although the exemplary data structure 700 of FIG. 7 (and 800 of FIG. 8), carries zone or boundary ID (and tag ID) information in a MAC header, in at least some embodiments consistent with the claimed invention, such information may be carried in the payload/data area 780.

Although, the exemplary data structure 800 of FIG. 8 is an LWAPP packet, at least some embodiments consistent with the present invention can communicate the zone or boundary ID and tag ID using other open or proprietary protocols used between the access points and the network infrastructure. In addition, in at least some embodiments consistent with the present invention, additional data (from sensors in the choke point or zone transmitter, and/or sensors in the tag for example) may be included in data packets sent from the transmitter to the tag, and/or in data packets sent from the tag to the access points.

### § 4.6 CONCLUSIONS

Embodiments consistent with the present invention may increase the accuracy and reliability of tracking and locating by using a unique combination of at least two locating technologies. Such embodiments may do so while reducing the costs for achieving a given level of accuracy and reliability. At least some embodiments consistent with the present invention may leverage existing standard technologies. At least some embodiments consistent with the claimed invention may solve at least some of the problems of current tag technologies. At least some embodiments consistent with the claimed invention may deliver room level location accuracy. At least some embodiments consistent with the claimed invention may provide choke point capabilities. At least some embodiments consistent with the claimed invention may provide RTLS capability. At least some embodiments consistent with the claimed invention may minimize additional infrastructure costs and maintenance costs. At least some embodiments consistent with the claimed invention may increase battery life of tags.

What is claimed is:

1. A method for combining information for locating a tag within a region, the region including a plurality of zone or boundary identifier transmitters and a plurality of access points, the method comprising:
a) receiving by the tag, from one of the plurality of zone or boundary identifier transmitters, a zone or boundary identifier;
b) transmitting by the tag, information identifying (1) the zone or boundary identifier and (2) a tag identifier associated with the tag, over at least two channels;
c) receiving by at least two of the plurality of access points, the information identifying (1) the zone or boundary identifier and (2) a tag identifier associated with the tag, transmitted by the tag;
d) transmitting, by each of the at least two of the plurality of access points, the information identifying (1) the zone or boundary identifier and (2) a tag identifier associated with the tag, as well as secondary information for use in deriving a location of the tag; and
e) storing (1) the zone or boundary identifier and (2) the tag identifier associated with the tag, and (3) the secondary information, in association with one another.

2. The method of claim 1 wherein the zone or boundary identifier received by the tag is received by an infra-red receiver.

3. The method of claim 1 wherein the zone or boundary identifier received by the tag is received by an ultra-sound receiver.

4. The method of claim 1 wherein the zone or boundary identifier received by the tag is received by a radio-frequency receiver.

5. The method of claim 5 wherein the radio-frequency receiver is one of a Zigbee receiver, an Ultra Wide Band receiver, and a Bluetooth receiver.

6. The method of claim 1 wherein the zone or boundary identifier is one of a zone identifier and a room identifier.

7. The method of claim 1 wherein the zone or boundary identifier is a boundary identifier.

8. The method of claim 1 wherein the zone or boundary identifier received by the tag is received by a receiver having a first state in which the receiver is enabled more frequently than a second state in which the receiver is enabled less frequently or disabled, the method further comprising:
detecting a motion of the tag; and
controlling the state of the receiver based on the detected motion of the tag.

9. The method of claim 1 wherein the act of transmitting by the tag, information identifying (1) the zone or boundary identifier and (2) a tag identifier associated with the tag, over at least two channels is performed by a WiFi transmitter.

10. The method of claim 9 wherein the WiFi transmitter has a first state in which the WiFi transmitter transmits more frequently than a second state in which the WiFi transmitter transmits less frequently or is disabled, the method further comprising:
detecting a motion of the tag; and
controlling the state of the WiFi transmitter based on the detected motion of the tag.

11. The method of claim 1 wherein the secondary information includes a received signal strength.

12. The method of claim 11 wherein the secondary information is included in a 802.11 message.

13. The method of claim 1 wherein the information identifying the zone or boundary identifier transmitted by the tag over at least two channels is included in a source MAC portion of a header of a 802.11 data packet.

14. The method of claim 1 wherein the information identifying a tag identifier associated with the tag transmitted by the tag over at least two channels is included in a transmitter MAC portion of a header of a 802.11 data packet.

15. The method of claim 1 further comprising:
f) determining a location of the tag using both (1) the zone or boundary identifier stored in association with the tag identifier associated with the tag, and (2) the secondary information stored in association with the tag identifier associated with the tag.

16. The method of claim 1 further comprising:
f) determining a first estimated location of the tag using the zone or boundary identifier stored in association with the tag identifier associated with the tag;
g) determining a second estimated location of the tag using the secondary information stored in association with the tag identifier associated with the tag; and
h) determining a refined location using the determined first estimated location and the determined second estimated location.

17. The method of claim 1 wherein at least one of the plurality of zone or boundary identifier transmitters is mobile.

18. The method of claim 17 wherein the tag is mobile.

19. The method of claim 17 wherein the tag is stationary.

21. The method of claim 1 wherein the tag is mobile.

22. The method of claim 21 wherein at least one of the plurality of zone or boundary identifier transmitters is mobile.

23. The method of claim 21 wherein at least one of the plurality of zone or boundary identifier transmitters is stationary.

24. A tag apparatus comprising:
a) a storage device storing a tag identifier for identifying the tag apparatus;
b) a receiver adapted to receive a zone or boundary identifier from a zone or boundary identifier transmitter;
c) a packet processor adapted to generate a packet including (1) a zone or boundary identifier received by the receiver and (2) the tag identifier stored in the storage device;
d) a transmitter adapted to transmit a packet generated by the packet processor over at least two channels, wherein a location of the tag can be derived from an attribute of receptions of the transmitted packet by at least two access point devices tuned to the at least two channels; and
e) an untethered power source.

25. The method of claim 24 wherein the untethered power source includes at least one of (A) a direct current batter, (B) a solar cell, (C) a thermal difference-based power source, and (D) an electromagnetic induction-based power source.

26. The tag apparatus of claim 24 further comprising:
f) a motion sensor for determining whether or not the tag apparatus is moving; and
g) a controller for controlling the receiver based on a determination of whether or not the tag apparatus is moving by the motion sensor.

27. The tag apparatus of claim 24 further comprising:
f) a motion sensor for determining whether or not the tag apparatus is moving; and
g) a controller for controlling the transmitter based on a determination of whether or not the tag apparatus is moving by the motion sensor.

28. The tag apparatus of claim 24 wherein the receiver is one of (A) an infra-red receiver, (B) an ultrasound receiver, and (C) a radio-frequency receiver, wherein a packet generated by the packet processor is a WiFi packet, and wherein the transmitter is a WiFi transmitter.

29. The tag apparatus of claim 24 wherein a packet generated by the packet processor is a WiFi packet having a header including a source MAC portion provided with a zone or boundary identifier received by the receiver.

30. The tag apparatus of claim 24 wherein a packet generated by the packet processor is a WiFi packet having a header including a transmitter MAC portion provided with the tag identifier.

31. A system comprising:
a) a tag including
1) a storage device storing a tag identifier for identifying the tag,
2) a receiver adapted to receive a zone or boundary identifier from a zone or boundary identifier transmitter,
3) a packet processor adapted to generate a packet including (i) a zone or boundary identifier received by the receiver and (ii) the tag identifier stored in the storage device,
4) a transmitter adapted to transmit a packet generated by the packet processor over at least two channels, and
5) an untethered power source; and
b) at least two access points, each of the at least two access points including
1) a receiver tuned to one of the at least two channels and adapted to receive a packet transmitted by the transmitter of the tag, and
2) a transmitter adapted to transmit a packet received by its receiver, as well as secondary information for use in deriving a location of the tag.
